(19) United States
(12) Patent Application Publication
(10) Pub. No.: US 2001/0042204 A1
(43) Pub. Date: Nov. 15, 2001

(54) Hash-ordered databases and methods, systems and computer program products for use of a hash-ordered database

(76) Inventors: David Blaker, Chapel Hill, NC (US); Dan Winkelstein, Raleigh, NC (US)

Correspondence Address: MYERS BIGEL SIBLEY & SAJOVEC, PO BOX 37428, RALEIGH, NC, 27627, US

(21) Appl. No.: 09/845,432

(22) Filed: Apr. 30, 2001

Related U.S. Application Data
(60) Provisional application No. 60/203,464, filed on May 11, 2000.

(51) Int. Cl. G06F 12/14; G06F 17/30

(52) U.S. Cl. 713/165; 713/193; 707/9

(57) ABSTRACT

Data structures and methods, systems and computer program products for searching, inserting and/or deleting entries in a database which includes a hash value corresponding to data of the entry and which are stored in a hash-ordered sequence such that a linear search for an entry from an address corresponding to the hash value of the entry will result in the data being located by examining entries in consecutive addresses before an address without an entry is reached are provided. Such methods, systems, computer program products and data structures may be particularly useful for Internet Protocol Security (IPSec) security association databases (SADs).

### PROVISIONAL APPLICATIONS

The present application is related to and claims priority from U.S. Provisional Patent Application Ser. No. 60/203,464, filed May 11, 2000 and entitled “METHODS AND APPARATUS FOR HIGH-PERFORMANCE HASH SEARCH” the disclosure of which is incorporated by reference as if set forth fully herein.

### FIELD OF THE INVENTION

The present invention relates to databases as well as the searching and maintenance of such databases, and more particularly to databases suitable for hash searching.

### BACKGROUND OF THE INVENTION

The Internet Protocol Security Architecture (IPSec), is a Virtual Private Network (VPN) technology. Typically, IPSec uses symmetric keys to secure traffic between peers. These symmetric keys are generated and distributed by an Internet Key Exchange (IKE) function. IPSec uses security associations (SAs) to provide security services to traffic. SAs are unidirectional logical connections between two IPSec systems. SAs associated with inbound packets may be uniquely identified by the triplet of <Security Parameter Index, IP Destination Address, Security Protocol>. To provide bidirectional communications, typically, two SAs are defined, one in each direction.

SAs are managed by IPSec systems maintaining two databases: a Security Policy Database (SPD) and a Security Associations Database (SAD). The SPD specifies what security services are to be offered to the IP traffic. Typically, the SPD contains an ordered list of policy entries which are separate for inbound and outbound traffic. These policies may specify, for example, that some traffic must not go through IPSec processing, some traffic must be discarded and some traffic must be IPSec processed.

The SAD contains parameter information about each SA. Such parameters may include the security protocol algorithms and keys for Authentication Header (AH) or Encapsulating Security Payload (ESP) security protocols, sequence numbers, protocol mode and SA lifetime. With IPSec in place, for outbound packets, the SPD is consulted to determine if IPSec processing is required or if other processing or discarding of the packet is to be performed. If IPSec is required, the SAD is searched for an existing SA for which the packet matches the profile. If a SA is found or after negotiation of a SA, IPSec is applied to the packet as defined by the SA and the packet is delivered. For inbound packets, the SPD is consulted to determine if IPSec or other processing is required. If IPSec is required, the SAD is searched for an existing security parameter index to match the security parameter index of the inbound packet. The SA is then used to IPSec process the inbound packet.

In operation, the SAD may include a large number of SAs. This may present performance problems unless the SAD may be quickly searched to locate a particular SA. However, the searching of the SAD typically involves searching for an exact match of a long string in a large database. Preferably, this search is performed very quickly. Furthermore, because the SAD may be updated with new SAs it is also preferable that the searching processes not be interrupted by the insertion or deletion of entries.

Conventional search methods used for hardware based searches include:

1. direct search using content addressable memory (CAM);

2. tree-search approach such as a binary search;

3. hash approach;

4. direct memory look-up; and

5. linear search.

Each one of these methods has limitations in terms of speed, database size, search field size, and the ability to update the database.

CAM devices are, typically, limited to a fixed field length and a maximum database size. Presently, field sizes of about 256 bits wide and database depths of about 8000 entries are provided. CAM devices may be very fast and have predictable search times. For an application with IPSec, CAM devices typically have too small a database and too small a field size to meet some important requirements. CAMs may also be approximately 64 times more expensive per bit than Synchronous Dynamic Random Access Memories (SDRAMs).

Tree-search approaches, such as a binary search, have the advantage of supporting arbitrarily large databases and field sizes, and may also have bounded search times. However, in a tree-search, the entries must be strictly ordered. This makes fast insertions and deletions of entries problematic since the entire database may have to be re-sorted if an entry at the beginning of the tree is inserted or deleted.

Hash-based approaches have the advantage of supporting arbitrarily large databases and field sizes. However, with hash approaches, the search time is a priori undeterminable. Additionally, hash tables that use linear probing typically must stop searching until a delete operation is complete, because this may require reinserting multiple entries. Additionally, certain hash-based approaches utilize linked lists or tree relationships in the event of a hash collision such that the collision is resolved by a tree-search or evaluation of a linked list. Such approaches may result in additional complexity which may increase cost or reduce performance.

Direct memory look-up may be fast but may be limited in field length and, therefore, may not be practical for long words such as may be used in an IPSec security association database.

Linear searches may not be practical for some applications, including IPSec, because performance degrades linearly with database size.

Accordingly, in light of the above discussion, improvements may be needed in database structures, searching and/or maintenance for large databases such as, for example, a SAD in an IPSec system.

### SUMMARY OF THE INVENTION

Embodiments of the present invention provide data structures and methods, systems and computer program products for searching, inserting and/or deleting entries in a database which includes a hash value corresponding to data of the entry and which are stored in a hash-ordered sequence such that a linear search for an entry from an address corresponding to the hash value of the entry will result in the data being located by examining entries in consecutive addresses before an address without an entry is reached. Such methods, systems, computer program products and data structures may be particularly useful for Internet Protocol Security (IPSec) security association databases (SADs).

In particular embodiments of the present invention, a database, such as a SAD, may be searched by generating a hash key value based on a plurality of selector values and selecting an entry in the database having an address corresponding to the hash key value. The entries in the database include corresponding hash values. The selected entry is evaluated to determine if the entry in the database corresponds to the plurality of selector values. The address corresponding to the hash key value is incremented (i.e. moved to the next address in the database) if the selected entry does not correspond to the plurality of selector values. This selection, evaluation and incrementing of the address are repeated until the selected entry has a hash value that indicates that subsequent entries in the database will not correspond to the plurality of selector values. For example, the entry having a null value or the hash value included in the selected entry having a value greater than the hash key value may be indicators that the search has failed.

In further embodiments of the present invention, the selection, evaluation and incrementing of the address are repeated until an entry corresponding to the plurality of selector values is reached. In such embodiments, the selected entry is provided if the selected entry corresponds to the plurality of selector values and an indicator of failure of the search is provided if the selected entry has a null value or includes a hash value which indicates failure of the search. Failure of a search may be indicated by a hash value of an entry being greater than the hash key value. In embodiments of the present invention where the database is in a circular memory, failure of the search may be indicated by the hash value of a current selected entry being less than the hash value of a previous selected entry and greater than the hash key value.

In particular embodiments of the present invention where the database is in a circular or wrap-around memory, the hash value may indicate failure of the search if the hash value of the entry in the database at the address corresponding to the hash key value is not greater than the hash key value and the hash value of an entry at a current address is greater than the hash key value. Similarly, failure may be indicated by the hash value of the entry in the database at the address corresponding to the hash key value being greater than the hash key value and the hash value of an entry at an immediately previous address being less than or equal to the hash key value and the hash value of the entry at the current address being greater than the hash key value. Additionally, in such embodiments, incrementing the address may be provided by incrementing the address to a next consecutive address if the address is less than a maximum address of the circular memory and setting the address to a first address of the circular memory if the address is equal to the maximum address of the circular memory.

In further embodiments of the present invention, the hash key value may be generated based on a plurality of selector values by encrypting the selector values to provide the hash key value. In particular, the selector values may be encrypted by grouping the plurality of selector values into blocks having a predefined number of bits, padding the blocks of grouped selector values to the predefined number of bits, encrypting the padded blocks, and truncating the encrypted padded blocks to a number of bits in the hash key value to provide the hash key value. The padded blocks may be encrypted using Cipher-Block-Chaining encryption mode of Data Encryption Standard (DES-CBC) encryption. Furthermore, the database may be an Internet Protocol Security (IPSec) security association database, the plurality of selector values may be IPSec selector fields and the predefined number of bits may be 64 bits.

In embodiments of the present invention where the database is an Internet Protocol Security (IPSec) security association database and the plurality of selector values are IPSec selector fields, the database may have a size of about four times a maximum number of supported security associations.

In still further embodiments of the present invention, entries are inserted into a database by generating a hash key value based on a plurality of selector values associated with the data for entry into the database and incorporating the data and the hash key value as an entry into the database at an address in the database which maintains entries in the database in hash key value sequence such that a linear search for the data from an address corresponding to the hash key value will result in the data being located by examining entries in consecutive addresses in the database before an address in the database without an entry is reached. Furthermore, incorporating the data and the hash key value as an entry into the database may be carried out utilizing only atomic read and/or write operations such that inserting data for entries into the database can be carried out simultaneously with a search of the database.

In particular embodiments, the data and the hash key value may be incorporated as an entry into the database by determining an address in the database closest to an address in the database corresponding to the hash key value for which the database does not have an entry and inserting the data and the hash key value as an entry in the database at the determined address if the determined address is the address corresponding to the hash key value. The data and the hash key value are inserted in the database at a next subsequent address after the address corresponding to the hash key value which is after an address of an entry in the database having an associated hash value of less than or equal to the hash key value and before an entry in the database having an associated hash value of greater than the hash key value if the entry located at the address corresponding to the hash key value is not empty. Data and hash key values are shifted from the next subsequent address to an address just prior to the determined address to provide entries in the database from an address just after the next subsequent address to the determined address if the entry located at the address corresponding to the hash key value is not empty.

In embodiments of the present invention where the database is a circular memory, the data and the hash key value are inserted at a next subsequent address after the address corresponding to the hash key value. The next subsequent address is immediately after an address of an entry in the database having an associated value of less than a hash value of an entry in the database at the next subsequent address and either the hash key value is greater than the next subsequent address or the hash key value is both less than the next subsequent address and less than the hash value of the entry in the database at the next subsequent address.

In still further embodiments of the present invention, data is deleted from a database by generating a hash key value based on a plurality of selector values associated with the data for deletion from the database, locating an entry in the database which includes the data and the hash key value and deleting the located entry. A subset of the entries in the database are reordered so as to maintain entries in the database in hash key value sequence such that a linear search for the data from an address corresponding to the hash key value will result in the data being located by examining entries in consecutive addresses in the database before an address in the database without an entry is reached. Furthermore, deleting the located entry and reordering a subset of the entries in the database may be carried out utilizing only atomic read and/or write operations such that deleting data from the database can be carried out simultaneously with a search of the database.

In such embodiments, the entry in the database may be located by the search operations described above. In particular embodiments, the located entry is deleted and the entries reordered by replacing the located entry in the database with a null entry if a next entry immediately after the located entry is a null entry. Furthermore, the located entry in the database may be replaced with a null entry if the next entry immediately after the located entry is at an address in the database corresponding to a hash value of the next entry immediately after the located entry. Similarly, in additional embodiments, an entry at a current address of the database may be replaced with an entry at a next subsequent address in the database if the current address is not before an address of the located entry and the next subsequent entry is not at an address in the database corresponding to a hash value of the next subsequent entry after the located entry. In still further embodiments, an entry at a current address of the database is replaced with an entry at a next subsequent address in the database if the current address is not before an address of the located entry and the next subsequent entry is not at an address in the database corresponding to a hash value of the next subsequent entry after the located entry or if the next subsequent entry is a null entry.

In still further embodiments of the present invention, searching a database stored in a circular memory is provided by generating a hash key value based on a plurality of selector values, selecting an entry in the database having an address corresponding to the hash key value, wherein entries in the database include corresponding hash values, evaluating the selected entry to determine if the entry in the database corresponds to the plurality of selector values. Most significant bits of a hash value of the selected entry and most significant bits of the hash key value are evaluated to determine if a wrap condition has occurred. The most significant bits of the hash value of the selected entry and the most significant bits of the hash key value are inverted if a wrap condition has occurred. The hash key value is compared to the hash value of the selected entry to determine if the hash value of the selected entry is greater than the hash key value and the address corresponding to the hash key value is incremented if the selected entry does not correspond to the plurality of selector values and the hash value of the selected entry is greater than the hash key value.

In additional embodiments of the present invention, the database is an Internet Protocol Security (IPSec) security association database and the plurality of selector values comprise IPSec selector fields.

In still further embodiments of the present invention, the database has a size of about four times a maximum number of supported security associations and the most significant bits are the two most significant bits. In such embodiments, evaluating the most significant bits may be provided by determining if the two most significant bits of the hash value of the current entry are “11” and the two most significant bits of the hash key value are “00” or if the two most significant bits of the hash value of the selected entry are “00” and the two most significant bits of the hash key value are “11”.

In additional embodiments of the present invention, inserting data for entries into a database stored in a circular memory is provided by generating a hash key value based on a plurality of selector values associated with the data for entry into the database, selecting an entry in the database having an address corresponding to the hash key value, wherein entries in the database include corresponding hash values, determining an end of a cluster of database entries by incrementing the address corresponding to the hash key value and selecting the corresponding entry in the database until an entry after the selected entry is empty, evaluating most significant bits of a hash value of the selected entry and most significant bits of the hash key value to determine if a wrap condition has occurred, inverting the most significant bits of the hash value of the selected entry and the most significant bits of the hash key value if a wrap condition has occurred, comparing the hash key value to the hash value of the selected entry to determine if the hash value of the selected entry is greater than the hash key value, copying the selected entry to an entry immediately after the selected entry if the hash value of the selected entry is greater than the hash key value, decrementing the address corresponding to the hash key value if the hash value of the selected entry is greater than the hash key value, and copying the data into an entry immediately after the selected entry if the hash value of the selected entry is greater than the hash key value.

Additionally, the selected entry may be compared to the data to determine if a duplicate entry is to be inserted into the database and a failure indication returned if a duplicate entry is to be inserted into the database. Furthermore, the data may be copied to the selected entry of the selected entry is empty.

In additional embodiments of the present invention, a data structure is provided having a plurality of data entries, each of the plurality of data entries has an associated address and includes a hash value associated with the data which is generated from a plurality of selector values which uniquely identify the data. The data structure also includes a plurality of null entries having an associated address other than an address in the data structure associated with a data entry. The address associated with a data entry is based on the hash value of the data entry such that a linear search for the data entry from an address corresponding to the hash value of the data entry will result in the data entry being located by examining entries in consecutive addresses before an address with a null entry is reached.

The addresses associated with the data entries may be in ascending order based on the hash values of the data entries. The addresses associated with the data entries may, alternatively, be in descending order based on the hash values of the data entries. The addresses may also be consecutive addresses. Furthermore, for a circular memory, a next consecutive address from a last address of the data structure is a first address of the data structure. The total number of data entries and null entries in the data structure may also be greater than a total number of potential unique data entries such the a total number of addresses in the data structure is greater than the total number of potential unique entries. In particular embodiments, the total number of addresses is about four times the total number of potential unique entries. In further embodiments, the data structure is an Internet Protocol Security (IPSec) Security Association Database (SAD), the data of the data entries is IPSec security association (SA) information and the hash values are hash keys generated from selector fields of the SAs.

In still further embodiments of the present invention, a system for managing Internet Protocol Security (IPSec) security associations (SAs) is provided. The system includes a hash key generator configured to generate hash key values based on modified selectors fields of Internet Protocol (IP) packets, the modified selector fields identifying a SA associated with the packet. A SA data structure is operably associated with the hash key generator and configured to store SA information and associated hash key values in hash-ordered sequence such that a linear search for a SA from an address of the data structure corresponding to a hash key value generated from the modified selector fields identifying the SA will result in the SA being located by examining SAs at consecutive addresses before an address with a null entry is reached. Furthermore, the SA data structure may be further configured to incorporate SAs and their corresponding hash key values into the data structure at an address in the data structure which maintains the SAs in the data structure in hash key value sequence such that a linear search for a SA from an address of the data structure corresponding to a hash key value generated from the modified selector fields identifying the SA will result in the SA being located by examining SAs at consecutive addresses before an address with a null entry is reached. The SA data structure may also be configured to locate a SA in the database for deletion, delete the located SA and reorder SAs in the data structure so as to maintain the SAs in the data structure in hash key value sequence such that a linear search for a SA from an address of the data structure corresponding to a hash key value generated from the modified selector fields identifying the SA will result in the SA being located by examining SAs at consecutive addresses before an address with a null entry is reached.

As will further be appreciated by those of skill in the art, the present invention may be embodied as methods, apparatus/systems and/or computer program products.

### BRIEF DESCRIPTION OF THE DRAWINGS

FIG. 1 is a block diagram of an IPSec processing system incorporating embodiments of the present invention;

FIG. 2 is a flowchart of operations for hash key generation according to embodiments of the present invention;

FIGS. 3A through 3C are block diagrams illustrating a data structure of databases and database operations according to embodiments of the present invention;

FIG. 4 is a flowchart illustrating operations for searching a database according to embodiments of the present invention;

FIG. 5 is a flowchart illustrating operations for searching a database in a circular memory according to embodiments of the present invention;

FIG. 6 is a flowchart illustrating operations for inserting an entry into a database according to embodiments of the present invention;

FIG. 7 is a more detailed flowchart illustrating operations for cluster parsing and movement to insert an entry into a database according to embodiments of the present invention; and

FIG. 8 is a flowchart illustrating operations for deleting an entry in a database according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention can take the form of an entirely hardware embodiment, an entirely software (including firmware, resident software, micro-code, etc.) embodiment, or an embodiment containing both software and hardware aspects. Furthermore, the present invention can take the form of a computer program product on a computer-usable or computer-readable storage medium having computer-usable or computer-readable program code means embodied in the medium for use by or in connection with an instruction execution system. In the context of this document, a computer-usable or computer-readable medium can be any means that can contain, store, communicate, propagate, or transport the program for use by or in connection with the instruction execution system, apparatus, or device.

The computer-usable or computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a removable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

The present invention can be embodied as data structures, systems, methods, and/or computer program products which allow for high performance hash-based searching of a database. Embodiments of the present invention may utilize a hash-ordered database which incorporates hash values as part of the entries of the database. As described in more detail below, the hash values incorporated in the database may be used to maintain the hash ordering of the database when inserting and deleting entries. The hash ordering of the database and the hash values being included in the entries of the database may also allow for early detection of a failed search.

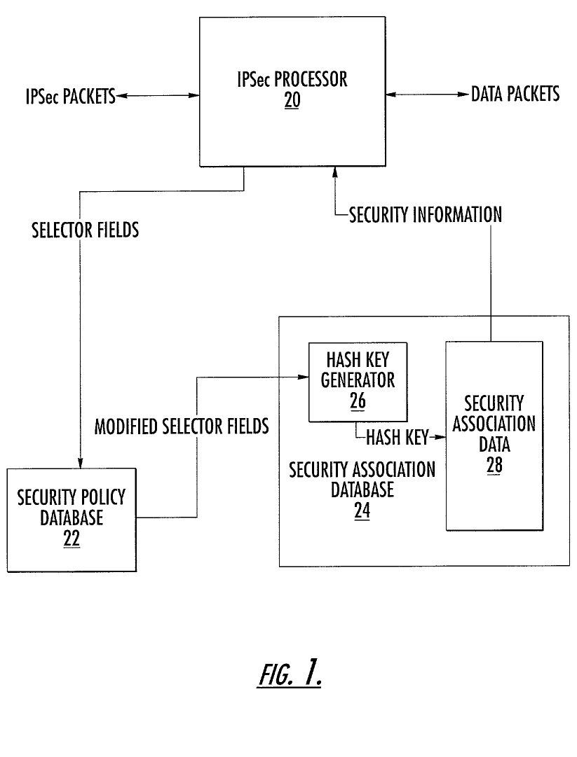

Embodiments of the present invention will now be described with reference to FIGS. 1 through 8 which are flowchart and block diagram illustrations of operations of protocol stacks incorporating embodiments of the present invention. It will be understood that each block of the flowchart illustrations and/or block diagrams, and combinations of blocks in the flowchart illustrations and/or block diagrams, can be implemented by computer program instructions. These program instructions may be provided to a processor to produce a machine, such that the instructions which execute on the processor create means for implementing the functions specified in the flowchart and/or block diagram block or blocks. The computer program instructions may be executed by a processor to cause a series of operational steps to be performed by the processor to produce a computer implemented process such that the instructions which execute on the processor provide steps for implementing the functions specified in the flowchart and/or block diagram block or blocks.

Accordingly, blocks of the flowchart illustrations and/or block diagrams support combinations of means for performing the specified functions, combinations of steps for performing the specified functions and program instruction means for performing the specified functions. It will also be understood that each block of the flowchart illustrations and/or block diagrams, and combinations of blocks in the flowchart illustrations and/or block diagrams, can be implemented by special purpose hardware-based systems which perform the specified functions or steps, or combinations of special purpose hardware and computer instructions.

FIG. 1 illustrates particular embodiments of the present invention which may be utilized for IPSec applications. As seen in FIG. 1 an IPSec processor 20 receives and provides data packets and receives and provides IPSec packets. The data packets may be unprocessed packets, packets with IPSec removed, packets for further IPSec processing or the like and are considered as input packets for packets to be IPSec processed by the IPSec processor 20 and output packets for packets processed by the IPSec processor 20. The IPSec processor 20 associates various fields in the IPSec packets or the data packets with security data. As described above, the process for associating packets with security data in an IPSEC security system is a two-fold process. The first part of the look-up process searches a small security policy database (SPD) 22 for entries corresponding to selected fields from a packet. The second part of the look-up process is to search a much larger security association (SA) database (SAD) 24 for an exact match of selected fields from the packet.

In general, a received packet is received by the IPSec processor 24 and relevant selector fields extracted from the packet. The SPD 22 is searched to determine if the traffic matches a set of general security policies. A CAM or other traditional search method can be used to see if the selectors of the incoming packet match one of the policies. If the search is successful, the output of the policy database search is a modified set of selectors. As described above, the inbound SAs may be uniquely identified by the source and destination IP address and the security protocol. Because of wildcarding, additional information may, however, be needed to uniquely identify outbound SAs. Such information may include, for example, destination and source addresses, the transport protocol, the source and destination ports and a policy identifier. Thus, for a given SA, differing selectors may be needed to uniquely identify the SA. Furthermore, in light of the ability to wildcard certain selectors, the packet selector field may be modified by the SPD to indicate which fields are relevant. IPSec standards provide for multiple SAs for a given policy. The modified selector fields are a subset of the traffic value selector fields plus an indication of the policy associated with the SPD. Some of the selector fields may be masked as dictated by the policy.

Accordingly, as is illustrated in FIG. 1, the IPSec processor 20 provides the selector fields to the security policy database 22 which provides the modified selector fields to a hash key generator 26 of the SAD 24 which generates a hash key which is used for searching the security association data 28. The security association data 28 is preferably maintained in a data structure as described in more detail herein and the hash key is used to search the security association data 28 utilizing the operations described herein. Additionally, in particular embodiments of the present invention, operations described herein for inserting and/or deleting data so as to maintain the security association data 28 in the data structure may also be utilized. The SAD 24 provides the identified security information, if any, to the IPSec processor 20 so that the IPSec processor 20 may process the packet, for example, to apply or remove IPSec. In particular embodiments, the security information may be encryption information associated with a given IP packet. In particular, through the use of the database structures and/or methods of embodiments of the present invention, a very large SAD 28 may be searched for modified selector fields quickly and in a manner such that the SAD 28 can be updated concurrently with searches.

Details for packet processing by the IPSec processor 20 are described in RFC 2401, Security Architecture for the Internet Protocol, The Internet Society (November 1998), the disclosure of which is incorporated herein by reference as if set for the fully herein. Thus, packet processing by the IPSec processor 20 will not be described further herein.

The IPSec processor 20, SPD 22 and SAD 24 may be provided as an entirely hardware embodiment, an entirely software embodiment or a combination of hardware and software. Thus, for example, the IPSec processor 20 may be a general purpose processor or a special purpose processor, such as a digital signal processor, programmed to carry out operations described herein, an application specific integrated circuit (ASIC) or other hardware implementations or as a combination thereof. Similarly, the SPD 22 may be implemented as described above or may be implemented as software and a database in memory or storage of a general purpose data processing system or a special purpose processor or combinations thereof. Finally, the SAD 24 may be implemented in hardware, in software including a database in memory or storage of a general purpose data processing system or a special purpose processor, or combinations thereof. For example, the hash key generator 26 may be provided by a hardware encryption device and the security association data 28 may be provided as a data structure stored in memory or storage and controlled by software executing on a general or specific purpose processor. Thus, the blocks in FIG. 1 may be considered logical modules or components and should not be limited to particular implementations.

Similarly, while embodiments of the present invention are described with reference to the particular architecture and interactions of the blocks of FIG. 1, as will be appreciated by those of skill in the art in light of the present disclosure, the present invention should not be construed as limited to such architecture and interactions but is intended to cover other configurations capable of carrying out the operations described herein. For example, while the hash key generator 26 is described as part of the SAD 24, the hash key generator 26 need not be incorporated in the SAD 24 but could be incorporated in other blocks, such as the IPSec processor 20, or provided as a standalone component or module. Similarly, the modified selector fields could be provided to the IPSec processor 20 before they are provided to the SAD 24.

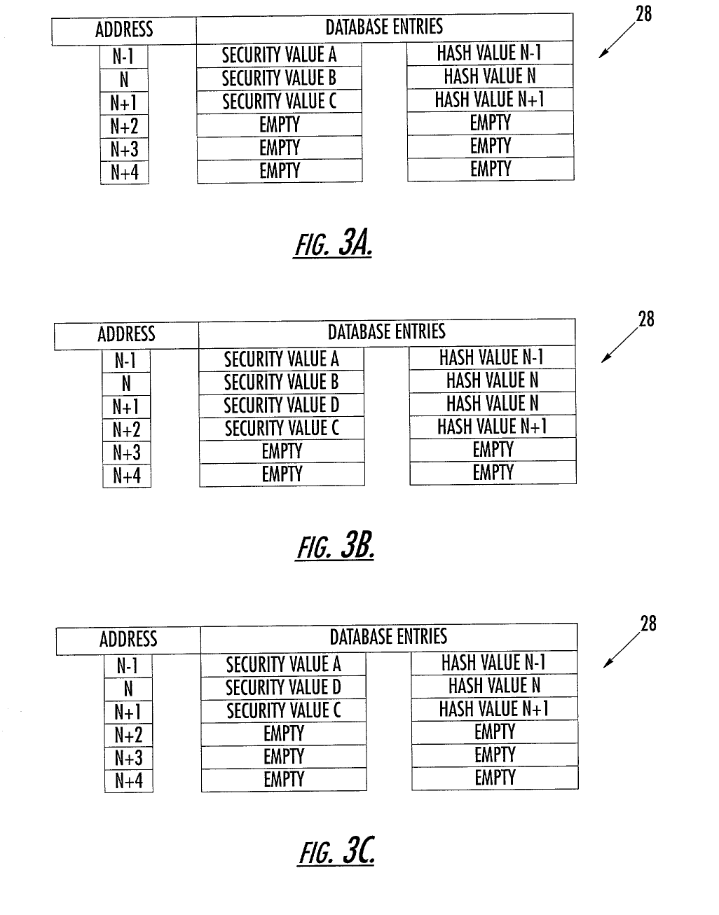

Embodiments of the present invention provide a database, such as the SAD 24, which is accessed using a hash search. A hash key may be generated from information which uniquely identifies the contents of an entry in the database and utilized as a pointer into the database. The entries in the database are maintained in a hash-ordered sequence and include, as part of their entries, the hash key for the entry. In certain embodiments of the present invention, the database may be sized such that there are more possible database addresses than there are potential unique entries. Thus, the data structure according to these embodiments of the present invention provides a data structure having more addresses for entries in the data structure than possible unique entries. Entries in the data structure include data and a hash value associated with the data. The entries are ordered in the data structure in hash value sequence. Entries having the same hash value are stored in a contiguous block of addresses in the data structure. The data structure also includes empty or null values at addresses in the data structure which do not have a corresponding entry. Entries are stored in the data structure at the address corresponding to the hash value of the entry or at a subsequent address to the address corresponding to the hash value of the entry which maintains the hash-ordered sequence of the entries. In particular embodiments of the present invention, the data structure may be a circular data structure or memory such that the next subsequent address after the last address in the data structure is the first address in the data structure. Such a data structure may provide for efficient searching and may also provide for insertions and deletions which may be carried out while the database utilizing such a data structure is being searched. An example of a database structure according to embodiments of the present invention is illustrated in FIGS. 3A through 3C which are described in more detail below.

Databases as described above may be searched and entries inserted or deleted utilizing operations as described herein. Each of such operations involve the generation of a hash key. Hash key generation provides a mechanism for generating very random hash values, preferably, even with similar inputs. In particular embodiments of the present invention, hash keys may be generated utilizing an encryption algorithm such as the Data Encryption Standard (DES). Other algorithms that produce repeatable pseudo-random results for a given input may also be utilized. Encryption algorithms may be particularly well suited for use in embodiments of the present invention, however, because any single bit change in the input field will, in general, produce randomly dispersed hash keys. Also, typically, the randomness of the resulting hash key does not depend on the order of specific fields of the input values. Encryption algorithms may also operate very quickly in hardware and the size of the hash key can easily be expanded or contracted while retaining pseudo-random distribution for any given input.

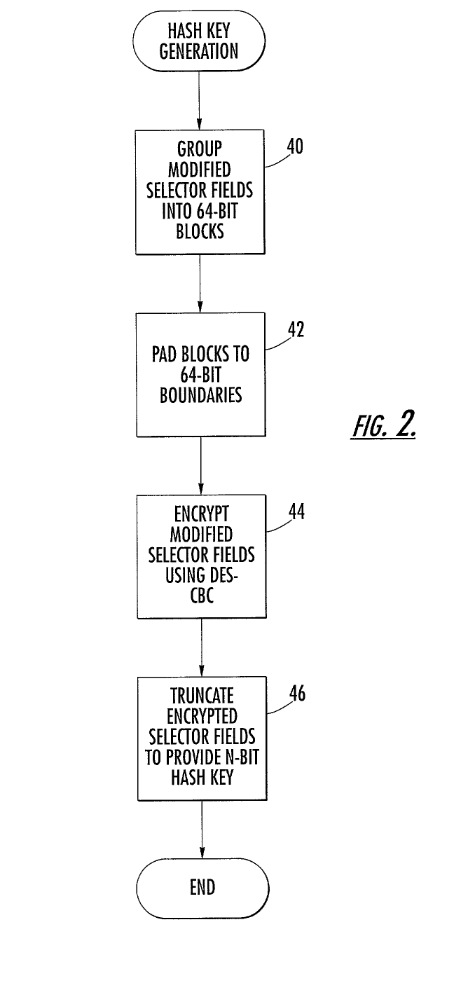

Operations for generating a hash key according to particular IPSec embodiments of the present invention utilizing Cipher-Block-Chaining mode of DES encryption (DES-CBC) are illustrated in FIG. 2. As seen in FIG. 2, the modified selector fields are grouped into 64-bit blocks (block 40) and the blocks are padded to the block size of 64-bits (block 42), which is the block size of DES. Using a constant known encryption key and a constant known initial vector, the 64-bit blocks are each encrypted using Cipher-Block-Chaining encryption mode of DES (DES-CBC) (block 44). When all of the blocks are encrypted, the resulting encryption of the selector fields is truncated to the number of bits in the hash key to generate a repeatable random key which provides the hash key for the SA corresponding to the modified selectors (block 46). This hash key may be used as described herein and may be stored with the entry corresponding to the modified selectors from which it was created.

FIG. 3A is an example of a data structure for storing security information, such as the security association data 28 of FIG. 1. As seen in FIG. 3A the entries in the data structure at a given address include security values, such as IPSec SAs, and a hash value corresponding to the security values. Thus, Security Value A has a corresponding hash value of N−1 which corresponds to the hash key generated by the selectors for Security Value A. As such, Security Value A is stored in Address N−1 or a next subsequent address after Address N−1 which maintains the hash-ordered sequence of the data structure. Security Value B has a corresponding hash value of N which corresponds to the hash key generated by the selectors for Security Value B. As such, Security Value B is stored in Address N or a next subsequent address after Address N which maintains the hash-ordered sequence of the data structure. Finally, in the example illustrated in FIG. 3A, Security Value C has a corresponding hash value of N+1 which corresponds to the hash key generated by the selectors for Security Value C. As such, Security Value C is stored in Address N+1 or a next subsequent address after Address N+1 which maintains the hash-ordered sequence of the data structure.

FIG. 3B is an example of the insertion of an entry into the data structure of FIG. 3A. As seen in FIG. 3B, the entry for Security Value D, which includes a hash value of N which corresponds to the hash key generated by the selectors for Security Value D, is inserted at address N+1 and the entry for Security Value C has been copied to address N+2. Thus, Security Value D has been inserted into the data structure of FIG. 3A so as to maintain the hash-ordered sequence of entries in the data structure such that an entry is stored in the address corresponding to its hash value or a next subsequent address which maintains the hash ordering.

FIG. 3C is an example of the deletion of an entry from the data structure of FIG. 3B. As seen in FIG. 3C, the entry for Security Value B has been removed. Thus, to maintain the hash ordering of the data structure and the entries being stored in the address corresponding to their hash value or a next subsequent address, the entries for Security Value D and Security Value C have been copied up one address to addresses N and N+1 respectively. Had the entry for Security Value D also been deleted, the entry for Security Value C would not be copied because it is already stored at the address corresponding to its hash value. An entry stored at the address corresponding to its hash value is referred to herein as being stored in its “natural location” or “natural address.”

As described above, to search the data structures according to embodiments of the present invention, the hash key generated from the selectors corresponding to a desired entry may be used as a pointer to the address in the data structure from which to start a linear search for an exact match between the modified selector fields and entries in the data structure. If the hash keys which are generated have a random distribution within the data structure address space, then the lower the ratio of entries to table size, the smaller the probability of a “cluster” of entries of a specific size being created. In particular IPSec embodiments of the present invention, the SAD can be designed to have four times the number of addresses as the maximum number of supported SAs. In particular, a system can support 262,144 unique SAs and the SAD can have room for 1,048,576 entries. Provided the hash key generation is random, one can expect uniform distribution of entries across the SAD.

A “cluster” forms when two modified selectors resolve to the same exact hash key such that one of the entries corresponding to the hash key cannot be placed in its natural location. In this case, the conflict can be resolved by placing the second SA in the slot immediately after the first item. Furthermore, there exists a mathematical probability that subsequent slots are occupied. Conventionally, the new item would be placed at the first free space after the address pointed to by the hash key (i.e., a heap). However, according to embodiments of the present invention, the hash-ordered sequence of the data structure is maintained. Thus, placing the entry in sequence may displace other entries from their natural locations. A cluster is formed of entries which are not empty or null and which are at consecutive addresses in the data structure. The cluster may contain entries having different hash values and runs from the address just after an empty address to the address just before an empty address.

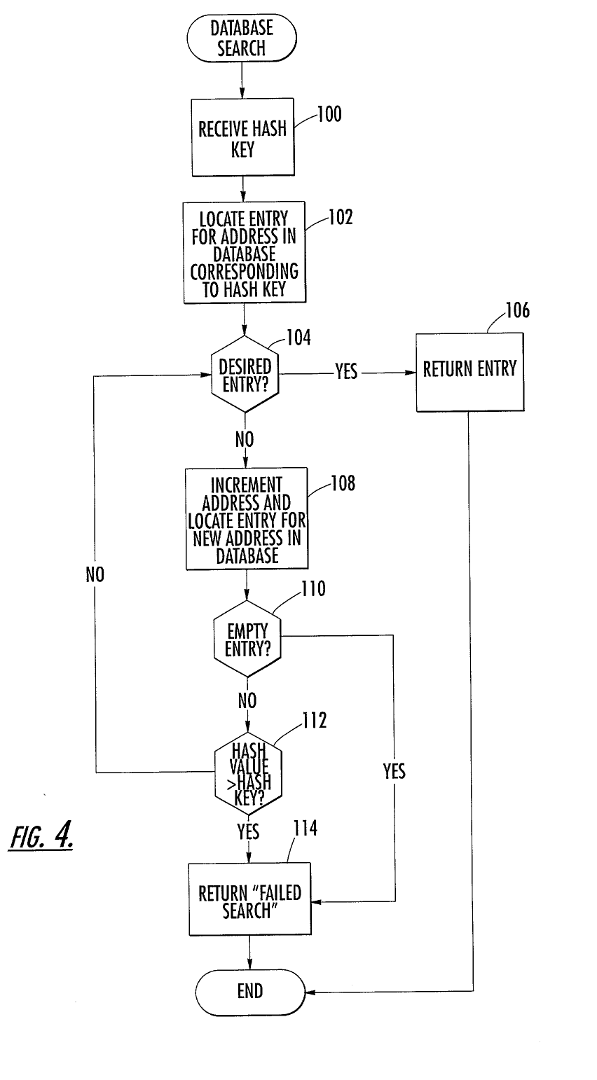

Operations for searching, inserting entries into and deleting entries from, data structures according to embodiments of the present invention will now be described with reference to the examples of FIGS. 3A through 3C, the flowchart illustrations of FIGS. 4 through 8 and the block diagram of FIG. 1. Turning to searching operations, as seen in FIG. 4, the hash key is obtained from the hash key generator 26 for the modified selector fields for an entry to be found in the SAD 28 (block 100). The hash key is used to obtain an entry at the address in the data structure corresponding to the hash key value (block 102). The entry is evaluated to determine if the entry is the desired entry (block 104). Such a determination may be made, for example, by comparing the hash value of the entry to the hash key value for a match. If a match exists, the modified selector field values which generated the hash key value may be compared to the modified selector fields of the entry for correspondence. Alternatively, the hash comparison could be skipped and only the modified selector fields compared. If correspondence is found, the entry is the desired entry (block 104) and the desired entry is returned to the IPSec processor 20 (block 106).

However, if the entry is not the desired entry (block 104), the address is incremented to the next address in the data structure and the entry for that address obtained (block 108). In circular memory embodiments of the present invention, incrementing the address may involve circling back to the first address of the data structure if the current address is the last address in the data structure. If the obtained entry is empty (block 110), then no match was found in the data structure for the desired entry and a “failed search” response may be provided to the IPSec processor 20 (block 114). If the entry is not empty (block 110), then the hash value of the entry may be evaluated to determine if the hash value is greater than the hash key value (block 112). Because the entries are maintained in hash-ordered sequence, for noncircular memory embodiments, if the entry has a hash value greater than the hash key value, then it indicates that the desired entry was not found as the subsequent entries in the data structure will also have higher hash values than the hash key value. For circular memory embodiments, additional evaluation may be needed as described below. Thus, if the hash value of the entry is greater than the hash key value of the desired entry (block 112) the “failed search” response maybe provided to the IPSec processor 20 (block 114). If the hash value of the entry is not greater than the hash key value (block 112), operations may continue from block 104. These operations may repeat until either the desired entry is found, an empty or null entry is found or an entry with a greater hash value than the hash key value is found.

As an example, the hash key value generated by the hash key generator 26 may be N and the SA to be located may be Security Value D. In the data structure in FIG. 3A, the entry at address N would be examined and found to have the same hash value as the hash key value. The modified selector fields which generated the hash key value would then be compared to fields from Security Value B and found not to match. Thus, the entry at the next address, N+1, would be evaluated and found to have a hash value of N+1, which is greater than N. Thus, the “failed search” indication would be provided. In the data structure of FIG. 3B, however, after evaluating the entry at address N the entry at address N+1 would be evaluated and found to have a hash value which matched the hash key value and fields matching the modified selector fields. Thus, the Security Value D would be provided.

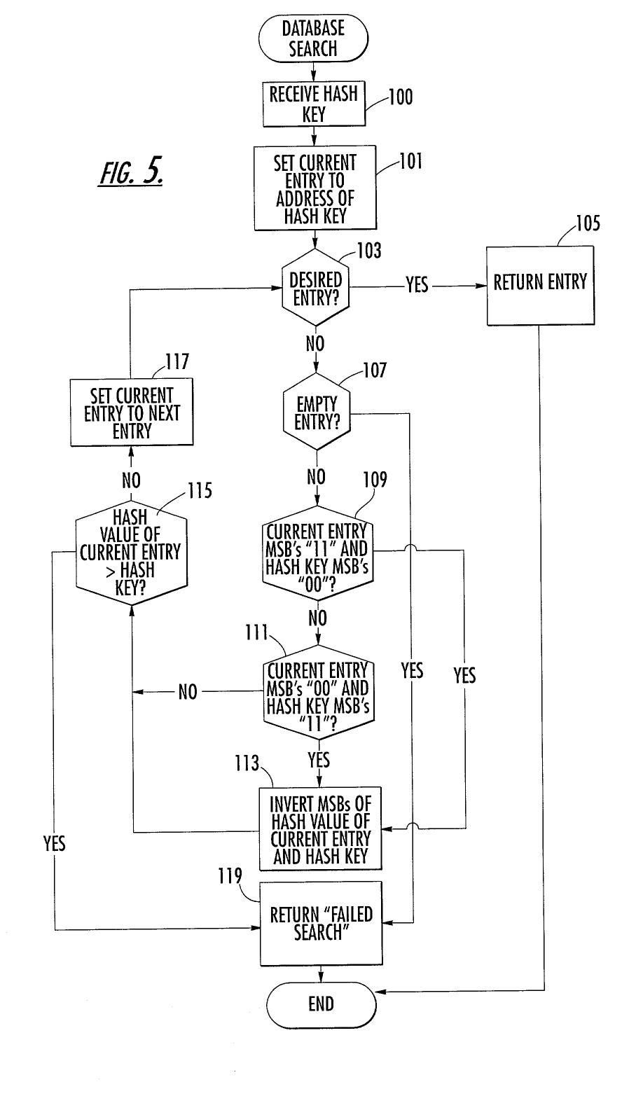

FIG. 5 illustrates operations for searching a database according to embodiments of the present invention where the database is in a circular or wraparound memory such that incrementing from the last memory address in the database results in returning to the first address of the database. The operations illustrated in FIG. 5 may detect that an entry at a given address is from a cluster which has wrapped from the end of memory and, therefore, a simple comparison of the hash value of the entry to the hash key value would provide an erroneous result. Thus, the end of the wrapped cluster may be found and the search operations for non-wrapped entries carried out from that point for searches which were begun at the beginning of the memory or the end of the cluster may indicate that a search has failed for a search which began at the end of memory and wrapped to the beginning of memory. One mechanism which may be used to determine that an entry is from a cluster which has wrapped from the end of memory is to compare the hash value of the entry to the address of the entry. If the hash value of the entry is greater than the address of the entry, then the entry is from a cluster which has wrapped from the end of memory.

Additionally, however, where the size of memory is greater than the total number of entries, the most-significant bits of consecutive entries may be evaluated to detect the wrap condition. For example, in an embodiment where the size of the memory is at least four times the total number of possible entries, if the two most significant bits of the hash value of an entry at “11” and the two most significant bits of the hash value of a next entry are “00” then the entry has wrapped from the end of memory. These bits may be inverted and the same comparison as is used for a non-wrap condition used in the search. Such a searching technique for wrapped memory is illustrated in FIG. 5.

Searching begins by obtaining a hash key value, such as described above, which corresponds to the entry to be located (block 100). The current entry for evaluation is set to the entry corresponding to the hash key value (block 101). The current entry is evaluated to determine if it is the desired entry (block 103), as has been described above, and if so the entry is returned (block 105). If the entry is not the desired entry (block 103), it is determined if the entry was an empty entry (block 107). If so, then the search has failed and a “failed search” response may be provided (block 119). If the entry is not empty (block 107), it is determined if both the two most significant bits of the hash value of the entry are “11” and the two most significant bits of the hash key value are “00” (block 109). If so, then the entry has wrapped around from the end of the database and the two most significant bits of the hash value of the current entry and the hash key value are inverted (block 113). If not, it is determined if both the two most significant bits of the hash value of the entry are “00” and the two most significant bits of the hash key value are “11” (block 111). If so, then the entry has wrapped around from the end of the database and the two most significant bits of the hash value of the current entry and the hash key value are inverted (block 113). If not, then the entry has not wrapped.

In either case, the hash value entry, possibly modified as described above, is compared to the hash key value (block 115). If the hash value entry is greater than the hash key value (block 115), then the search has failed and the failed search indication is returned (block 119). If the hash value entry is not greater than the hash key value, then the current entry is set to the next entry in the database (block 117) and the evaluation operations beginning at block 103 are repeated for the new current entry. These operations are repeated until either the entry is the desired entry, the entry is empty or the entry has a hash value greater than the hash key value.

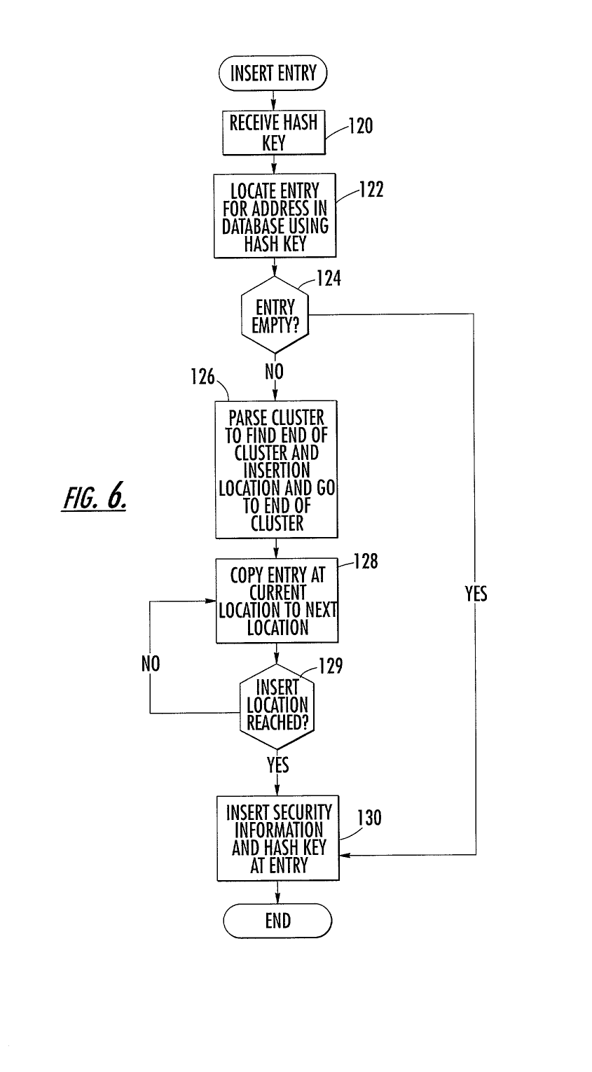

FIG. 6 illustrates operations for inserting an entry into a data structure according to embodiments of the present invention so as to maintain the hash-ordered sequence of the data structure. As seen in FIG. 6, the hash key value is obtained from the hash key generator 26 (block 120). The entry at the address in the data structure corresponding to the hash key value is located and obtained (block 122) and it is determined if the entry is empty (block 124). An entry may be considered empty, for example, if it has a “NULL” value. Thus, the data structure may be initialized to all NULL values which would then be overwritten by SA information. In any event, if the entry at the address corresponding to the hash key value is empty (block 124), the security information and the hash key value are stored at that address (block 130).

If the entry at the address corresponding to the hash key value is not empty (block 124), a cluster exists and the cluster is parsed to find the end of the cluster (the last address before an address with an empty entry) and the insertion location which will maintain the data structure in hash-ordered sequence and a current location is set to the end of the cluster (block 126). Entries at and after the insertion location are copied to a location of the next entry to provide an insertion location. Such may be accomplished by copying the entry at the current location to the next location beginning with the end of the cluster (block 128) and repeating the copy of entries until the insertion location is reached (block 129). The security information and hash key value may then be stored at the insertion location (block 130).

By utilizing only copy operations, the insert operation may be considered a number of atomic copy operations which maintain the integrity of the hash-ordered structure of the database during the insert operation. Thus, because the values in the database and the structure in the database are maintained, searches may be performed while an insert operation is being carried out. Accordingly, multiple searches and insertions may be interleaved.

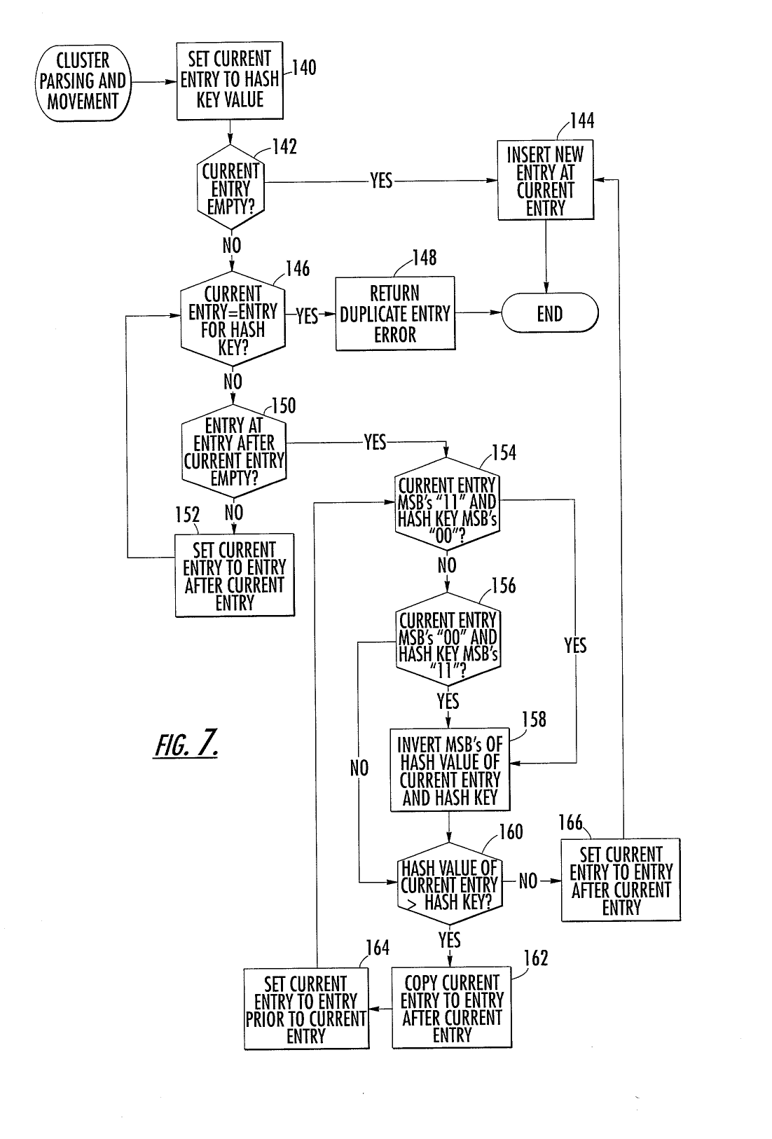

FIG. 7 illustrates operations for locating an insertion location and inserting an entry in a cluster for circular memory embodiments of the present invention. The operations of FIG. 7 may correspond to the operations of blocks 122, 124, 126, 128 and 130 of FIG. 6. The operations illustrated in FIG. 7 may detect that an entry at a given address is from a cluster which has wrapped from the end of memory and, therefore, a simple comparison of the hash value of the entry to the hash key value to determine the insert location would provide an erroneous result. Thus, the end of the wrapped cluster may be found and the search operation to determine an insert location for non-wrapped entries carried out from that point for searches which began at the beginning of the memory or the end of the cluster may indicate the insertion point for a search which began at the end of memory and wrapped to the beginning of memory. One mechanism which may be used to determine that an entry is from a cluster which has wrapped from the end of memory is to compare the hash value of the entry to the address of the entry. If the hash value of the entry is greater than the address of the entry, then the entry is from a cluster which has wrapped from the end of memory.

In general, the location to insert a new entry may be determined by determining if the hash key value is less than the value of the hash value of the a current entry and is greater than or equal to the hash value of the entry after the current entry. If so, then the insertion location for the new entry value(s) is the entry after the current location. However, for circular or wrap-around memory embodiments of the present invention, additional conditions exist where such a test may be insufficient by itself to establish the insertion location. Thus, even if these conditions are not met, it may be determined if the hash value of the entry after the current entry is less than the hash value of the current entry. This can only be the case if the entries have wrapped around from the end of the data structure. If this wrap condition is met, then if either the hash key is greater than the address of the entry after the current entry (i.e. the entry to be inserted was to be inserted at the end of the data structure but has wrapped to the beginning) or the hash key is less than the address of the entry after the current entry and less than the hash value of the entry after the current entry (i.e. the entry to be inserted was to be inserted at the beginning of the data structure but its natural location was occupied by an entry that wrapped from the end of the data structure), the insertion location will be the location of the entry after the current entry.

Additionally, however, where the size of memory is greater than the total number of entries, the most-significant bits of consecutive entries may be evaluated to detect the wrap condition. For example, in an embodiment where the size of the memory is at least four times the total number of possible entries, if the two most significant bits of the hash value of an entry at “11” and the two most significant bits of the hash value of a next entry are “00” then the entry has wrapped from the end of memory. These bits may be inverted and the same comparison as is used for a non-wrap condition used in determining an insertion location. Such a technique for determining an insertion location for wrapped memory embodiments of the present invention is illustrated in FIG. 7.

Furthermore, the insertion location for the new entry in the embodiments illustrated in FIG. 7 is after any existing entries which have the same hash value as the hash key. By placing the new entry at the end of the sequence of existing entries having the same hash value, the number of entries which may require moving may be reduced. However, if it is determined that new entries in the data structure are searched for more often than older entries, then it may be beneficial to place the new entries at the beginning of the sequence of entries having the same hash value. If such is the case, then the test for determining the insertion point could be modified to test if the hash key value was equal to the hash value of an entry and, if so, then the insertion location would be set to the address of that entry.

As seen in FIG. 7, the current entry is set to the hash key value (block 140). The value of the current entry is evaluated to determine if it is empty (block 142) and, if so, the new entry value(s) and the hash key value are inserted at the current entry (block 144). This is the case where the natural address of the entry is empty. If the natural address of the entry is not open, a duplicate entry test is performed by comparing the current entry to the entry to be inserted (block 146). If a duplicate is found, a duplicate entry error is returned (block 148) and operations end.

If the entry is not a duplicate (block 146), it is determined if the entry after the current entry is empty (block 150). If so, then the end of the cluster has been reached. If not, the current entry is set to the entry after the current entry (e.g. the current entry address of the is incremented) (block 152). In a circular or wrap-around memory, the current address may be incremented by setting the address to address+1 MOD MAX_ADDRESS where MAX_ADDRESS is the highest address value in the data structure. Otherwise in non-circular memory embodiments, the address may simply be incremented. After incrementing the address, operations continue from the duplicate entry test of block 146. These operations are repeated until an empty entry is located.

When an empty entry is located (block 150), it is determined if both the two most significant bits of the hash value of the current entry are “11” and the two most significant bits of the hash key value are “00” (block 154). If so, then the entry has wrapped around from the end of the database and the two most significant bits of the hash value of the current entry and the hash key value are inverted (block 158). If not, it is determined if both the two most significant bits of the hash value of the current entry are “00” and the two most significant bits of the hash key value are “11” (block 156). If so, then the entry has wrapped around from the end of the database and the two most significant bits of the hash value of the current entry and the hash key value are inverted (block 158). If not, then the entry has not wrapped.

In either case, the hash value of the current entry, possibly modified as described above, is compared to the hash key value (block 160). If the hash value of the current entry is greater than the hash key value (block 160), the current entry is copied to the entry after the current entry (block 162) and the current entry is set to the entry prior to the current entry (block 164). If the hash value of the current entry is not greater than the hash key value (block 160), the current entry is set to the entry after the current entry (block 166) and the new entry is inserted at the current entry (block 144).

Operations of FIGS. 6 and/or 7 may provide for inserting an entry in the SA look-up table such that the entry at the location pointed to by the hash key value is examined, and if it is a NULL entry, then the SA entry is placed at that location. If the location pointed to by the hash key value is occupied, the cluster is parsed to find a location to place the entry such that the hash values are always increasing within the cluster. This may be accomplished by parsing the cluster to find both the end of the cluster (location with a NULL entry) and the location to insert the current entry. If the current entry has a hash value that is greater than or equal to the hash value of the last entry in the cluster, the current entry is placed at the end of the cluster. If the current entry has a HASH value that is less than the HASH value of the last entry in the cluster, then entries are moved down one memory location in order to open up a location within the cluster to properly insert the current entry. Finally, if the cluster wraps around the end of the memory, the cluster will be ordered such that the highest value hash entry immediately precedes the lowest value HASH entry. When entries are moved down one memory location, the integrity of the cluster may be maintained by duplicating the last entry in a cluster into the NULL entry at the end of the cluster, and then duplicating the second-to-last entry in the cluster down one memory location. This continues until there is a space to insert the new entry.

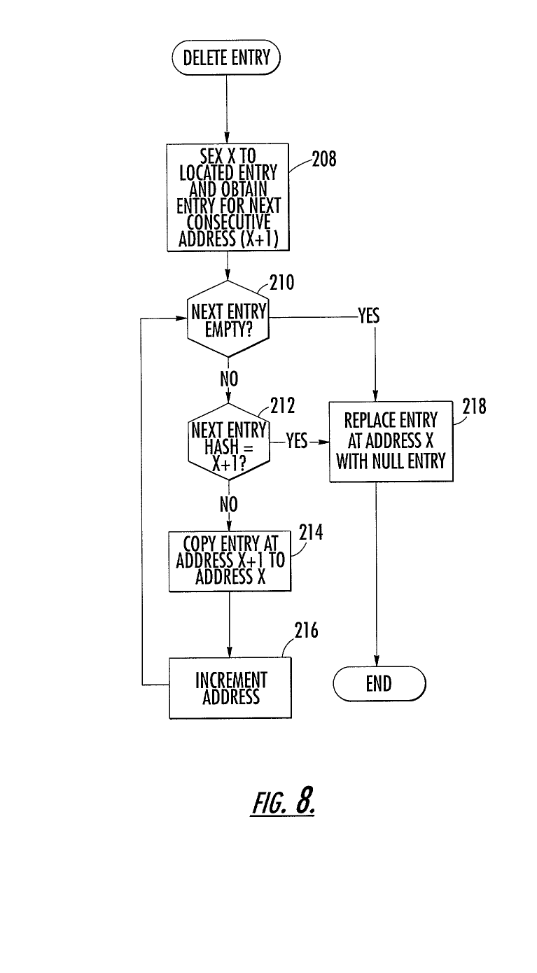

FIG. 8 illustrates operations for deleting any entry in a data structure according to embodiments of the present invention. The operations in FIG. 8 may be preceded by the operations described in FIGS. 4 or 5 so as to locate an entry to be deleted. Thus, operations of FIG. 8 may be seen as carried out after the operations of block 106 or block 105 of FIGS. 4 or 5. As seen in FIG. 8, once the desired entry has been located the address pointer “x” is set to the location of the desired entry and the entry of the next consecutive address, x+1, is obtained (block 208). If the next entry is empty (block 210), then no movement of entries is required and the entry at the address x is replaced with the NULL entry (block 218). However, if the next entry is not empty (block 210), then it is determined if the hash value of the entry at address x+1 is equal to the address x+1 (block 212) (i.e. the next entry is in its natural location). If this is the case, then the entry at the address x is replaced with the NULL entry (block 218).

If the entry at the address x+l is not in its natural location (block 212), then the entry at the address x+1 is copied to address x (block 214) and the address pointer x is incremented to x+1. Operations then continue at block 210, wherein, if the next entry after the address x is empty, the end of the cluster has been reached and the entry at address x is replaced with the NULL entry. If the end of the cluster has not been reached, then the operations of blocks 212, 214 and 216 are repeated until either the end of the cluster is reached or an entry in its natural location has been reached.

As described above, in embodiments of the present invention having a circular or wrap-around memory, incrementing the address to the next address may involve wrapping the address to the beginning of the memory. Thus, in such embodiments, references to addresses of x+1 refer to the next address in the sequence of addresses irrespective of whether the value of x+1 is greater than or less than the value of x.

While embodiments of the present invention have primarily been described with reference to a SAD and IPSec processing the present invention should not be construed as limited to such applications. Furthermore, while the data structures described herein are in ascending order by hash value, as will be appreciated by those of skill in the art in light of the present disclosure, descending order may also be utilized. Such a descending order could be created by, for example, subtracting the hash key from a maximum address of the data structure.

Additionally, the present invention has been described with reference to setting address values for a database. As will be appreciated by those of skill in the art, such address values may be memory addresses, offsets into memory segments, offsets into a memory array, or other such address values utilizing various addressing techniques. Accordingly, the present invention should not be construed as limited to address values which are identical to hash values but is intended to include address values which are based on hash values.

While the present invention has been described with respect to the data structure and hash key generator as part of the SAD, as will be appreciated by those of skill in the art, such functions may be provided as separate functions, objects or applications which may cooperate with each other, the SPD and the IPSec processor. Furthermore, the present invention has been described with reference to particular sequences of operations. However, as will be appreciated by those of skill in the art, other sequences may be utilized while still benefiting from the teachings of the present invention. Thus, while the present invention is described with respect to a particular division of functions or sequences of events, such divisions or sequences are merely illustrative of particular embodiments of the present invention and the present invention should not be construed as limited to such embodiments.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of searching a database, the method comprising:
generating a hash key value based on a plurality of selector values;
selecting an entry in the database having an address corresponding to the hash key value, wherein entries in the database include corresponding hash values;
evaluating the selected entry to determine if the entry in the database corresponds to the plurality of selector values;
incrementing the address corresponding to the hash key value if the selected entry does not correspond to the plurality of selector values;
wherein the selecting, the evaluating and the incrementing are repeated until the hash value included in selected entry has a value which indicates that entries subsequent to the selected entry will not correspond to the plurality of selector values.

2. A method according to claim 1, wherein the selecting, the evaluating and the incrementing are repeated until an entry corresponding to the plurality of selector values is reached or until the hash value included in the selected entry has a value which indicates that entries subsequent to the selected entry will not correspond to the plurality of selector values.

3. A method according to claim 1, wherein the selecting, the evaluating and the incrementing are repeated until the selected entry is a null entry.

4. A method according to claim 1, wherein the selecting, the evaluating and the incrementing are repeated until the selected entry has a hash value greater than the hash key value.

5. The method of claim 2, further comprising:
providing the selected entry if the selected entry corresponds to the plurality of selector values; and
providing an indicator of failure of the search if the selected entry includes a hash value other than the hash key value or the selected entry has a null value.

6. The method of claim 1, wherein generating a hash key value based on a plurality of selector values comprises encrypting the selector values to provide the hash key value.

7. The method of claim 6, wherein encrypting the selector values to provide the hash key value comprises:
grouping the plurality of selector values into blocks having a predefined number of bits;
padding the blocks of grouped selector values to the predefined number of bits;
encrypting the padded blocks; and
truncating the encrypted padded blocks to a number of bits in the hash key value to provide the hash key value.

8. The method of claim 7, wherein encrypting the padded blocks comprises encrypting the padded blocks using Cipher-Block-Chaining encryption mode of Data Encryption Standard (DES-CBC) encryption.

9. The method of claim 8, wherein the database comprises an Internet Protocol Security (IPSec) security association database, the plurality of selector values comprise IPSec selector fields and the predefined number of bits comprises 64 bits.

10. The method of claim 1, wherein the database comprises an Internet Protocol Security (IPSec) security association database and the plurality of selector values comprise IPSec selector fields.

11. The method of claim 10, wherein the database has a size of about four times a maximum number of supported security associations.

12. The method of claim 1, wherein the database is contained in a circular memory and wherein incrementing the address comprises:
incrementing the address to a next consecutive address if the address is less than a maximum address of the circular memory; and
setting the address to a first address of the circular memory if the address is equal to the maximum address of the circular memory.

13. The method of claim 12, wherein the selecting, the evaluating and the incrementing are repeated until a hash value of the selected entry is less than a hash value of a previous selected entry and the hash value of the selected entry is greater than the hash key value.

14. A method of inserting data for entries into a database, comprising:
generating a hash key value based on a plurality of selector values associated with the data for entry into the database; and
incorporating the data and the hash key value as an entry into the database at an address in the database which maintains entries in the database in hash key value sequence such that a linear search for the data from an address corresponding to the hash key value will result in the data being located by examining entries in consecutive addresses in the database before an address in the database without an entry is reached.

15. The method of claim 14, wherein incorporating the data and the hash key value as an entry into the database is carried out utilizing only atomic read and/or write operations such that inserting data for entries into the database can be carried out simultaneously with a search of the database.

16. The method of claim 14, wherein incorporating the data and the hash key value as an entry into the database comprises:
determining an address in the database closest to an address in the database corresponding to the hash key value for which the database does not have an entry;
inserting the data and the hash key value as an entry in the database at the determined address if the determined address is the address corresponding to the hash key value;
inserting the data and the hash key value in the database at a next subsequent address after the address corresponding to the hash key value which is after an address of an entry in the database having an associated hash value of less than or equal to the hash key value and before an entry in the database having an associated hash value of greater than the hash key value if the entry located at the address corresponding to the hash key value is not empty; and
shifting data and hash key values from the next subsequent address to an address just prior to the determined address to provide entries in the database from an address just after the next subsequent address to the determined address if the entry located at the address corresponding to the hash key value is not empty.

17. The method of claim 16, wherein the database comprises a circular memory, the method further comprising inserting the data and the hash key value at a second next subsequent address after the address corresponding to the hash key value, where the second next subsequent address is immediately after an address of an entry in the database having an associated value of less than a hash value of an entry in the database at the second next subsequent address and either the hash key value is greater than the second next subsequent address or the hash key value is both less than the second next subsequent address and less than the hash value of the entry in the database at the second next subsequent address.

18. The method of claim 14, wherein generating a hash key value based on a plurality of selector values comprises encrypting the selector values to provide the hash key value.

19. The method of claim 18, wherein encrypting the selector values to provide the hash key value comprises:
grouping the plurality of selector values into blocks having a predefined number of bits;
padding the blocks of grouped selector values to the predefined number of bits;
encrypting the padded blocks; and
truncating the encrypted padded blocks to a number of bits in the hash key value to provide the hash key value.

20. The method of claim 19, wherein encrypting the padded blocks comprises encrypting the padded blocks using Cipher-Block-Chaining encryption mode of Data Encryption Standard (DES-CBC) encryption.

21. The method of claim 19, wherein the database comprises an Internet Protocol Security (IPSec) security association database, the plurality of selector values comprise IPSec selector fields and the predefined number of bits comprises 64 bits.

22. The method of claim 14, wherein the database comprises an Internet Protocol Security (IPSec) security association database and the plurality of selector values comprise IPSec selector fields.

23. The method of claim 22, wherein the database has a size of about four times a maximum number of supported security associations.

24. A method of deleting data from a database, the method comprising:
generating a hash key value based on a plurality of selector values associated with the data for deletion from the database;
locating an entry in the database which includes the data and the hash key value;
deleting the located entry; and
reordering a subset of the entries in the database so as to maintain entries in the database in hash key value sequence such that a linear search for the data from an address corresponding to the hash key value will result in the data being located by examining entries in consecutive addresses in the database before an address in the database without an entry is reached.

25. The method of claim 24, wherein deleting the located entry and reordering a subset of the entries in the database are carried out utilizing only atomic read and/or write operations such that deleting data from the database can be carried out simultaneously with a search of the database.

26. The method of claim 24, wherein locating an entry in the database comprises:
selecting an entry in the database having an address corresponding to the hash key value, wherein entries in the database include corresponding hash values; evaluating the selected entry to determine if the entry in the database corresponds to the plurality of selector values;
incrementing the address corresponding to the hash key value if the selected entry does not correspond to the plurality of selector values;
wherein the selecting, the evaluating and the incrementing are repeated until an entry corresponding to the plurality of selector values is reached.

27. The method of claim 24, wherein deleting the located entry and reordering entries in the database comprises replacing the located entry in the database with a null entry if a next subsequent entry after the located entry is a null entry.

28. The method of claim 27, wherein deleting the located entry and reordering entries in the database further comprises replacing the located entry in the database with a null entry if the next subsequent entry after the located entry is at an address in the database corresponding to a hash value of the next subsequent entry after the located entry.

29. The method of claim 28, wherein deleting the located entry and reordering entries in the database further comprises replacing an entry at a current address of the database with an entry at a next subsequent address in the database if the current address is not before an address of the located entry and the next subsequent entry is not at an address in the database corresponding to a hash value of the next subsequent entry after the located entry.

30. The method of claim 25, wherein deleting the located entry and reordering entries in the database further comprises replacing an entry at a current address of the database with an entry at a next subsequent address in the database if the current address is not before an address of the located entry and the next subsequent entry not at an address in the database corresponding to a hash value of the next subsequent entry after the located entry or if the next subsequent entry is a null entry.

31. The method of claim 24, wherein generating a hash key value based on a plurality of selector values comprises encrypting the selector values to provide the hash key value.

32. The method of claim 31, wherein encrypting the selector values to provide the hash key value comprises:
grouping the plurality of selector values into blocks having a predefined number of bits;
padding the blocks of grouped selector values to the predefined number of bits;
encrypting the padded blocks; and
truncating the encrypted padded blocks to a number of bits in the hash key value to provide the hash key value.

33. The method of claim 32, wherein encrypting the padded blocks comprises encrypting the padded blocks using Cipher-Block-Chaining encryption mode of Data Encryption Standard (DES-CBC) encryption.

34. The method of claim 33, wherein the database comprises an Internet Protocol Security (IPSec) security association database, the plurality of selector values comprise IPSec selector fields and the predefined number of bits comprises 64 bits.

35. The method of claim 24, wherein the database comprises an Internet Protocol Security (IPSec) security association database and the plurality of selector values comprise IPSec selector fields.

36. The method of claim 35, wherein the database has a size of about four times a maximum number of supported security associations.

37. A system searching a database, comprising:
means for generating a hash key value based on a plurality of selector values;
means for selecting an entry in the database having an address corresponding to the hash key value, wherein entries in the database include corresponding hash values;
means for evaluating the selected entry to determine if the entry in the database corresponds to the plurality of selector values;
means for incrementing the address corresponding to the hash key value if the selected entry does not correspond to the plurality of selector values;
means for repeatedly selecting, evaluating and incrementing until the selected entry has a null value or the hash value included in selected entry has a value other than the hash key value.

38. A system for inserting data for entries into a database, comprising:
means for generating a hash key value based on a plurality of selector values associated with the data for entry into the database; and
means for incorporating the data and the hash key value as an entry into the database at an address in the database which maintains entries in the database in hash key value sequence such that a linear search for the data from an address corresponding to the hash key value will result in the data being located by examining entries in consecutive addresses in the database before an address in the database without an entry is reached.

39. A system deleting data from a database, comprising:
means for generating a hash key value based on a plurality of selector values associated with the data for deletion from the database;
means for locating an entry in the database which includes the data and the hash key value;
means for deleting the located entry; and
means for reordering a subset of the entries in the database so as to maintain entries in the database in hash key value sequence such that a linear search for the data from an address corresponding to the hash key value will result in the data being located by examining entries in consecutive addresses in the database before an address in the database without an entry is reached.

40. A computer program product for searching a database, comprising:
a computer-readable storage medium having computer-readable program code embodied therein, the computer readable program code comprising:
computer-readable program code which generates a hash key value based on a plurality of selector values;
computer-readable program code which selects an entry in the database having an address corresponding to the hash key value, wherein entries in the database include corresponding hash values;
computer-readable program code which evaluates the selected entry to determine if the entry in the database corresponds to the plurality of selector values;
computer-readable program code which increments the address corresponding to the hash key value if the selected entry does not correspond to the plurality of selector values;
computer-readable program code which repeatedly selects, evaluates and increments until the selected entry has a null value or the hash value included in selected entry has a value other than the hash key value.

41. A computer program product for inserting data for entries into a database, comprising:
a computer-readable storage medium having computer-readable program code embodied therein, the computer readable program code comprising:
computer-readable program code which generates a hash key value based on a plurality of selector values associated with the data for entry into the database; and
computer-readable program code which incorporates the data and the hash key value as an entry into the database at an address in the database which maintains entries in the database in hash key value sequence such that a linear search for the data from an address corresponding to the hash key value will result in the data being located by examining entries in consecutive addresses in the database before an address in the database without an entry is reached.

42. A computer program product for deleting data from a database, comprising:
a computer-readable storage medium having computer-readable program code embodied therein, the computer readable program code comprising:
computer-readable program code which generates a hash key value based on a plurality of selector values associated with the data for deletion from the database;
computer-readable program code which locates an entry in the database which includes the data and the hash key value;
computer-readable program code which deletes the located entry; and
computer-readable program code which reorders a subset of the entries in the database so as to maintain entries in the database in hash key value sequence such that a linear search for the data from an address corresponding to the hash key value will result in the data being located by examining entries in consecutive addresses in the database before an address in the database without an entry is reached.

43. A data structure comprising:
a plurality of data entries, each of the plurality of data entries including a hash value associated with the data and which is generated from a plurality of selector values which uniquely identify the data and having an address associated therewith;
a plurality of null entries having an associated address other than an address in the data structure associated with a data entry;
wherein the address associated with a data entry is based on the hash value of the data entry such that a linear search for the data entry from an address corresponding to the hash value of the data entry will result in the data entry being located by examining entries in consecutive addresses before an address with a null entry is reached.

44. The data structure of claim 43, wherein the addresses associated with the data entries are in ascending order based on the hash values of the data entries.

45. The data structure of claim 43, wherein the addresses associated with the data entries are in descending order based on the hash values of the data entries.

46. The data structure of claim 43, wherein the addresses are consecutive addresses.

47. The data structure of claim 46, wherein a next consecutive address from a last address of the data structure is a first address of the data structure.

48. The data structure of claim 43, wherein a total number of data entries and null entries in the data structure is greater than a total number of potential unique data entries such the a total number of addresses in the data structure is greater than the total number of potential unique entries.

49. The data structure of claim 48, wherein the total number of addresses is about four times the total number of potential unique entries.

50. The data structure of claim 43, wherein the data structure comprises an Internet Protocol Security (IPSec) Security Association Database (SAD), the data of the data entries comprises IPSec security association (SA) information and the hash values comprise hash keys generated from selector fields of the SAs.

51. A system for managing Internet Protocol Security (IPSec) security associations (SAs), comprising:
a hash key generator configured to generate hash key values based on modified selectors fields of Internet Protocol (IP) packets, the modified selector fields identifying a SA associated with the packet; and
a SA data structure operably associated with the hash key generator and configured to store SA information and associated hash key values in hash-ordered sequence such that a linear search for a SA from an address of the data structure corresponding to a hash key value generated from the modified selector fields identifying the SA will result in the SA being located by examining SAs at consecutive addresses before an address with a null entry is reached.

52. A system according to claim 51, wherein the SA data structure is further configured to incorporate SAs and their corresponding hash key values into the data structure at an address in the data structure which maintains the SAs in the data structure in hash key value sequence such that a linear search for a SA from an address of the data structure corresponding to a hash key value generated from the modified selector fields identifying the SA will result in the SA being located by examining SAs at consecutive addresses before an address with a null entry is reached.

53. A system according to claim 51, wherein the SA data structure is further configured to locate a SA in the database for deletion, delete the located SA and reorder SAs in the data structure so as to maintain the SAs in the data structure in hash key value sequence such that a linear search for a SA from an address of the data structure corresponding to a hash key value generated from the modified selector fields identifying the SA will result in the SA being located by examining SAs at consecutive addresses before an address with a null entry is reached.

54. A method of searching a database stored in a circular memory, the method comprising:
generating a hash key value based on a plurality of selector values;
selecting an entry in the database having an address corresponding to the hash key value, wherein entries in the database include corresponding hash values;
evaluating the selected entry to determine if the entry in the database corresponds to the plurality of selector values;
evaluating most significant bits of a hash value of the selected entry and most significant bits of the hash key value to determine if a wrap condition has occurred;
inverting the most significant bits of the hash value of the selected entry and the most significant bits of the hash key value if a wrap condition has occurred;
comparing the hash key value to the hash value of the selected entry to determine if the hash value of the selected entry is greater than the hash key value; and
incrementing the address corresponding to the hash key value if the selected entry does not correspond to the plurality of selector values and the hash value of the selected entry is greater than the hash key value.

55. The method of claim 54, wherein the database comprises an Internet Protocol Security (IPSec) security association database and the plurality of selector values comprise IPSec selector fields.

56. The method of claim 54, wherein the database has a size of about four times a maximum number of supported security associations, the most significant bits comprises the two most significant bits and evaluating most significant bits comprises determining if the two most significant bits of the hash value of the current entry are “11” and the two most significant bits of the hash key value are “00” or if the two most significant bits of the hash value of the selected entry are “00” and the two most significant bits of the hash key value are “11”.

57. The method of claim 54, wherein incrementing the address comprises:
incrementing the address to a next consecutive address if the address is less than a maximum address of the circular memory; and
setting the address to a first address of the circular memory if the address is equal to the maximum address of the circular memory.

58. A method of inserting data for entries into a database stored in a circular memory, comprising:
generating a hash key value based on a plurality of selector values associated with the data for entry into the database;
selecting an entry in the database having an address corresponding to the hash key value, wherein entries in the database include corresponding hash values;
determining an end of a cluster of database entries by incrementing the address corresponding to the hash key value and selecting the corresponding entry in the database until an entry after the selected entry is empty;
evaluating most significant bits of a hash value of the selected entry and most significant bits of the hash key value to determine if a wrap condition has occurred;
inverting the most significant bits of the hash value of the selected entry and the most significant bits of the hash key value if a wrap condition has occurred;
comparing the hash key value to the hash value of the selected entry to determine if the hash value of the selected entry is greater than the hash key value;
copying the selected entry to an entry immediately after the selected entry if the hash value of the selected entry is greater than the hash key value;
decrementing the address corresponding to the hash key value if the hash value of the selected entry is greater than the hash key value; and
copying the data into an entry immediately after the selected entry if the hash value of the selected entry is greater than the hash key value.

59. The method of claim 58, wherein the database comprises an Internet Protocol Security (IPSec) security association database and the plurality of selector values comprise IPSec selector fields.

60. The method of claim 58, wherein the database has a size of about four times a maximum number of supported security associations, the most significant bits comprises the two most significant bits and evaluating most significant bits comprises determining if the two most significant bits of the hash value of the current entry are “11” and the two most significant bits of the hash key value are “00” or if the two most significant bits of the hash value of the selected entry are “00” and the two most significant bits of the hash key value are “11”.

61. The method of claim 58, further comprising:
comparing the selected entry to the data to determine if a duplicate entry is to be inserted into the database; and
returning a failure if a duplicate entry is to be inserted into the database.

62. The method of claim 58, further comprising copying the data to the selected entry of the selected entry is empty.
